(19) United States
(12) Patent Application Publication
(10) Pub. No.: US 2010/0212523 A1
(43) Pub. Date: Aug. 26, 2010

(54) PRINTED ITEM CONTACT MEMBER AND MEMBER FOR PRINTING APPARATUS

(75) Inventors: Hideaki Sakurai, Hiroshima-ken (JP); Masahito Kaneko, Hiroshima-ken (JP); Yasuharu Suda, Hiroshima-ken (JP); Katsuhiko Takeda, Hiroshima-ken (JP); Hiroyuki Yano, Hiroshima-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES ,LTD., Tokyo (JP)

(21) Appl. No.: 12/445,964

(22) PCT Filed: Oct. 17, 2007
(86) PCT No.: PCT/JP2007/070234

§ 371 Date: Apr. 17, 2009

(30) Foreign Application Priority Data
Oct. 26, 2006 (JP) 2006-291610

(51) Int. Cl. B41F 21/00

(52) U.S. Cl. 101/407.1

(57) ABSTRACT

A printed item contact member 54 according to the present invention includes: a base material 50; a fixing layer 52 that is formed on the surface of the base material 50 and substantially spherical particles 51 are fixed thereto; and a remarkably thin low-surface-tension coating layer 53 that covers the surface of the fixing layer 52 having the substantially spherical particles 51 fixed thereto and that exhibits release properties with respect to a printed item. The printed item contact member exhibits high ink repellency while maintaining the micro-uneven surface structure and is free from adhesion of yarn waste or dust to the member during cleaning, and therefore can be suitably used as, for example, a member for printing device in contact with the surface of printing paper.

### RELATED APPLICATIONS

The present application is based on, International Application No. PCT/JP2007/070234, filed Oct. 17, 2007 and claims priority from, Japan Application Number 2006-291610, filed Oct. 26, 2006, the disclosures of which are hereby incorporated by reference herein in their entirety.

### TECHNICAL FIELD

The present invention relates to a printed item contact member and a member for a printing apparatus.

### BACKGROUND ART

Generally, in a perfecting press, in about one second or shorter after the first printing, the printing surface is in contact with an impression cylinder for the second printing, so that a printing pressure is applied to the first printing surface. Thus, in a sheet-feed perfecting press, the wet ink on the first printing surface is transferred to the impression cylinder to cause uneven density or pinholes in the printing surface, or the ink attached to the impression cylinder is further transferred to the next paper to stain the paper surface, causing a difference in printing quality between the first printing surface and the second printing surface.

As a measure for preventing such adhesion of ink to the cylinder, there has been proposed a technique in which a base material for an impression cylinder having an uneven surface prevents the adhesion of ink utilizing an effect of contact at a point with the printing surface. In addition, a technique in which a material having excellent releasability is used on the surface of an impression cylinder has been proposed (for example, see Patent Documents 1 and 2).

Specific examples of techniques employed for obtaining a base material for an impression cylinder having an uneven surface include various methods, such as blasting the surface, glass bead coating of the surface, and ceramic spray coating of the surface.

Examples of materials having excellent releasability include silicone resins and fluorine resins.

A configuration example of preventing adhesion of ink formed in a conventional impression cylinder is shown in FIG. 12. As shown in FIG. 12, on the surface of a synthetic-resin coating layer 2 formed on the upper surface of a base metal plate 1, ceramic particles 4 having, for example, an average particle size of about 55 micrometers are provided through an adhesive 3 so that head portions of the ceramic particles 4 are exposed, and a low-surface-tension resin coating layer 6 made of a silicone resin or the like is formed to cover the head portions of the ceramic particles 4, providing a structure having an uneven surface with releasability (see Patent Documents 1 and 2). Reference numeral 5 denotes a composite coating film.

The head portions of the ceramic particles 4 are exposed to achieve a predetermined surface roughness (Rmax: 30 to 150 micrometers, for example) of the low-surface-tension resin coating layer 6 made of a silicone resin or the like, and for example, the formation of the low-surface-tension resin coating layer 6 having a thickness of about 2 micrometers at the head portions of the ceramic particles and a thickness of about 5 to 10 micrometers at the root portions has been proposed (see paragraphs [0074] and [0075] in Patent Document 1).

Patent Document 1: Japanese Patent Application Laid-open No. H08-12151

### Patent Document 2: Japanese Patent Application Laid-open No. 2005-1321

### DISCLOSURE OF INVENTION

### Problem to be Solved by the Invention

However, the method disclosed in Patent Document 2 shown in FIG. 12 has a problem such that, as the impression cylinder is constantly being used over a long period of time, the uneven surface of the low-surface-tension resin coating layer 6 is worn to expose the ceramic particles 4. The ceramic particles 4 have an angular shape, and therefore, when cleaning the surface of the impression cylinder, for example, yarn waste or dust from cleaning cloth or the like is attached to the exposed angular particles on the surface, causing deterioration of the printing quality. When the exposed particles on the surface are increased as the impression cylinder is constantly being used, there is a problem that an increased amount of yarn waste or dust is attached to the surface of the impression cylinder, and this makes it difficult to perform favorable cleaning.

To prevent such problems, in the production of printed item contact members, for example, a separate operation of abrading the exposed ceramic particles is conducted. However, in this case, a cleaning process requires a certain period of time, and an additional apparatus for abrading is needed, thus making it difficult to improve the production efficiency and achieve cost reduction.

In a printing process, when cleaning the surface of the impression cylinder, yarn waste or dust from cleaning cloth can be attached to the surface to cause deterioration of the printing quality, and therefore there is a problem that an additional cleaning operation for removing the yarn waste or dust is required, so that the cleaning needs a long time.

As in the conventional technique, a surface covered with a low-surface-tension coating layer using particles having a particle size as large as, for example, 55 micrometers and using a silicone resin has a surface roughness such that the roughness height is as large as 40 micrometers or more, and therefore the occurrence of pinholes (printing quality difference) cannot be satisfactorily prevented, making it difficult to fully prevent the deterioration of the printing quality.

In view of the above problems, an object of the present invention is to provide a printed item contact member and a member for a printing apparatus, each of which is favorable not only in that the member exhibits high ink repellency while maintaining a micro-uneven surface structure and is free from adhesion of yarn waste or dust to the member during cleaning, but also in that the member has both high durability and high printing quality.

### Means for Solving Problem

According to an aspect of the present invention, a printed item contact member includes: a base material; a fixing layer that is formed on a surface of the base material and substantially spherical particles are fixed thereto; and a low-surface-tension coating layer that covers a surface of the fixing layer having the substantially spherical particles fixed thereto and that exhibits release properties with respect to a printed item.

Advantageously, in the printed item contact member, the substantially spherical particles have a particle size of 1 to 20 micrometers, and the surface covered with the low-surface-tension coating layer has a surface roughness such that a height Rz is 5 to 20 micrometers and a roughness pitch Rs is 20 to 100 micrometers.

Advantageously, in the printed item contact member, the low-surface-tension coating layer has a thickness equal to or less than 1 micrometer.

Advantageously, in the printed item contact member, the fixing layer has a thickness of 5 to 30 micrometers.

According to another aspect of the present invention, a printed item contact member includes: a base material; a fixing layer that is formed on the surface of the base material and substantially spherical particles are fixed thereto; and a low-surface-tension coating layer that covers a surface of the fixing layer having the substantially spherical particles fixed thereto and that exhibits release properties with respect to a printed item. The low-surface-tension coating layer having a thickness equal to or less than 1 micrometer, and the low-surface-tension coating layer includes a compound having a low-surface-tension exhibiting unit in contact with a printed item and a chemical reaction unit that interacts with the surface of the base material.

According to still another aspect of the present invention, a printed item contact member includes: a base material; a fixing layer that is formed on the surface of the base material and substantially spherical particles are fixed thereto; and a low-surface-tension coating layer that covers a surface of the fixing layer having the substantially spherical particles fixed thereto and that exhibits release properties with respect to a printed item. The low-surface-tension coating layer having a thickness equal to or less than 1 micrometer, the low-surface-tension coating layer includes a compound having a low-surface-tension exhibiting unit in contact with a printed item and a chemical reaction unit that interacts with the surface of the base material, and the low-surface-tension coating layer includes a monomolecular layer of the compound.

Advantageously, in the printed item contact member, the chemical reaction unit includes an uneven surface having the substantially spherical particles and fixing layer formed on the surface of the base material, and a replacement reactive structure.

Advantageously, in the printed item contact member, the low-surface-tension exhibiting unit has fluorine atom.

Advantageously, in the printed item contact member, the compound constituting the low-surface-tension coating layer has a density higher than 2 molecule/nm².

Advantageously, the printed item contact member further includes a silica compound layer which is an intermediate layer between the base material and the low-surface-tension coating layer.

According to still another aspect of the present invention, a member for a printing apparatus includes any one of the above referenced printed item contact member.

Advantageously, in the member for a printing apparatus, the member is any one of an impression cylinder, a sample table, a vacuum suction system, or a color measurement apparatus.

### EFFECT OF THE INVENTION

In the present invention, the printed item contact member includes a base material, a fixing layer that is formed on the surface of the base material and substantially spherical particles are fixed thereto, and a low-surface-tension coating layer that covers the surface of the fixing layer having the substantially spherical particles fixed thereto and that exhibits release properties with respect to a printed item, and therefore the printed item contact member is favorable not only in that the member exhibits high ink repellency while maintaining a micro-uneven surface structure and is free from adhesion of yarn waste or dust to the member during cleaning, but also in that the member has high durability.

### BRIEF DESCRIPTION OF DRAWINGS

FIG. 1 is a schematic diagram of a printed item contact member according to an embodiment.

FIG. 2 is a schematic diagram of relevant parts of the printed item contact member according to the embodiment.

FIG. 3 is a schematic diagram of a configuration of the printed item contact member according to the embodiment.

FIG. 4 is another schematic diagram of a configuration of the printed item contact member according to the embodiment.

FIG. 5 is a schematic diagram of a chemical structure of the printed item contact member according to the embodiment.

FIG. 6 is a schematic diagram of another chemical structure of the printed item contact member according to the embodiment.

FIG. 7A is a schematic diagram of a state of bonding between a low-surface-tension coating layer and a fixing layer.

FIG. 7B is another schematic diagram of a state of bonding between the low-surface-tension coating layer and the fixing layer.

FIG. 7C is still another schematic diagram of a state of bonding between the low-surface-tension coating layer and the fixing layer.

FIG. 8 is a schematic diagram of an impression cylinder of a printing device.

FIG. 9 is a schematic diagram of a vacuum suction system.

FIG. 10 is a schematic diagram of a color measurement apparatus.

FIG. 11 is a schematic diagram of a roll coater method.

FIG. 12 is a configuration example of preventing adhesion of ink formed in a conventional impression cylinder.

### EXPLANATIONS OF LETTERS OR NUMERALS

50 base material
51 substantially spherical particle
52 fixing layer
53 low-surface-tension coating layer
54 printed item contact member
55 intermediate layer
12 low-surface-tension exhibiting unit
13 chemical reaction unit
21 first interaction (interaction between low-surface-tension coating layer and base material)
22 second interaction (interaction between adjacent molecules)

### BEST MODE(S) FOR CARRYING OUT THE INVENTION

Exemplary embodiments of the present invention will be explained below in detail with reference to the accompanying drawings. The embodiments are not intended to limit the present invention. In addition, constituent elements in the embodiments include those that can be easily assumed by those skilled in the art or that are substantially equivalent.

### Embodiments of the Invention

A printed item contact member according to an embodiment of the present invention will be explained below with reference to the drawings.

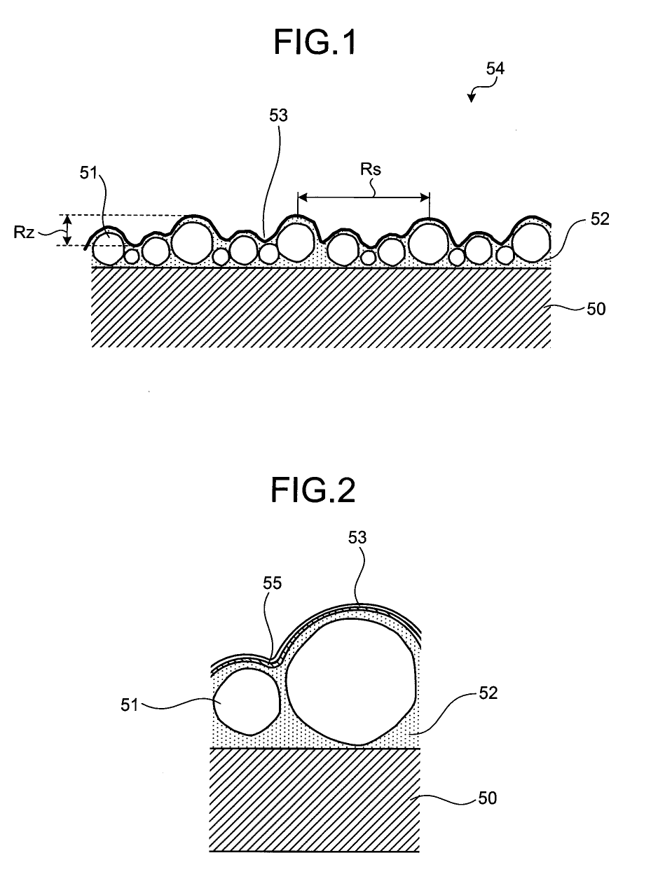

FIG. 1 is a schematic diagram of a printed item contact member according to the embodiment.

As shown in FIG. 1, a printed item contact member 54 according to the present embodiment includes a base material 50, a fixing layer 52 that is formed on the surface of the base material 50 and substantially spherical particles 51 are fixed thereto, and a remarkably thin low-surface-tension coating layer 53 that covers the surface of the fixing layer 52 having the substantially spherical particles 51 fixed thereto and that exhibits release properties with respect to a printed item.

As shown in FIG. 1, by having the remarkably thin low-surface-tension coating layer 53 that covers the surface of the fixing layer 52 having the substantially spherical particles 51 fixed thereto and that exhibits release properties with respect to a printed item, the printed item contact member 54 exhibits high ink repellency while fully maintaining the micro-uneven surface form comprised of the substantially spherical particles 51. In addition, by the use of the substantially spherical particles 51, the printed item contact member is free from adhesion of yarn waste or dust to the member during cleaning. As a result, the printed item contact member having high durability can be provided.

The substantially spherical particles 51, which are substantially spherical, are not particles having an angular shape produced by pulverization, for example, but are rounded and spherical particles. That is, the substantially spherical particles are particles having a spherical shape such that an apex having an acute angle (for example, 90° or less) is not exposed to the surface of the particle.

It is preferred that the substantially spherical particles 51 have a particle size of, for example, 1 to 20 micrometers. Because it is preferable that the particle size of the substantially spherical particles is equal to or less than 20 micrometers so as to maintain a roughness height of equal to or less than 10 micrometers.

With respect to the particle size of the substantially spherical particles 51, basically a nominal value from manufacturers can be used. With respect to the substantially spherical particles, for example, “CB-A10S” (average particle size: 10 micrometers), manufactured by SHOWA DENKO K.K., can be used.

The exemplified measurement method of the size of the particles is the Coulter counter method. By the Coulter counter method, the number of particles and a particle volume are determined from a change of the electric resistance in a pore caused when particles dispersed in a dispersion medium pass through the pore to which a voltage is applied.

With respect to the surface roughness of the surface covered with the low-surface-tension coating layer, for improving the printing quality due to contact, the roughness height Rz shown in FIG. 1 is 5 to 20 micrometers, and the roughness pitch Rs is 20 to 100 micrometers. When the roughness height is equal to or less than 20 micrometers, it is preferable in view of suppressing the occurrence of pinholes (printing quality difference). Meanwhile, when the roughness height is equal to or more than 5 micrometers, it is preferable because the surface can exhibit a support effect due to the contact at a point.

When the roughness pitch Rs is 20 to 100 micrometers, the surface having even a roughness height as small as equal to or less than 20 micrometers exhibits excellent force for maintaining the paper surface, making it possible to fully prevent the deterioration of printing quality.

The low-surface-tension coating layer 53 preferably has a thickness of 0.01 to 1 micrometer, more preferably a submicron thickness (0.1 micrometer) or less. In this case, the thickness of the low-surface-tension coating layer 53 is remarkably thin and therefore, even when the substantially spherical particles 51 have a small particle size, the gentle uneven surface formed from the substantially spherical particles 51 fixed to the fixing layer 52 can be reflected as it is, and thus achieving excellent printing quality.

That is, when a conventional low-surface-tension coating layer made of a thick silicone resin having a thickness as large as 20 micrometers is used, the thick layer covers the uneven form of surface, making it difficult to constitute excellent uneven surface, so that the printing quality is deteriorated, however, in the present invention, the low-surface-tension coating layer 53 having a remarkably small thickness can solve such a problem.

With respect to the thickness of the fixing layer 52, while there is no particular limitation as long as the fixing layer can reasonably maintain the spherical particles, the thickness of the fixing layer is preferably 5 to 30 micrometers, for example.

When the thickness of the fixing layer is equal to or more than 5 micrometers, more satisfactory bonding force for the particles can advantageously be achieved. On the other hand, when the thickness of the fixing layer is equal to or less than 30 micrometers, the particles are advantageously unlikely to be embedded in the fixing layer 52, facilitating the formation of a desired uneven surface.

By bonding and fixing the substantially spherical particles 51 with the fixing layer 52, the surfaces of the particles are covered with a thin layer of the material constituting the fixing layer, and therefore the bonding of the particles to the low-surface-tension coating layer 53 is firm, thus forming a strong coating film having releasability.

It is preferred that the low-surface-tension coating layer 53 is comprised of a compound having a low-surface-tension exhibiting unit in contact with a printed item and a chemical reaction unit that interacts with the surface of the base material.

Particularly, it is preferred that the low-surface-tension coating layer 53 includes a monomolecular layer of the compound.

With respect to the method of producing an uneven surface form, while there is no particular limitation, examples of the method include a dispersion bonding method and a particle incorporation method.

In the dispersion bonding method, an adhesive (for example, an epoxy resin) is applied to the base material 50 by a roll coater method (thickness: 5 to 20 micrometers), and the substantially spherical particles 51 (having an average particle size of 10 micrometers, for example) are dispersed in the adhesive and bonded with the base material due to electrostatic adhesion, obtaining a desired uneven surface form.

In the particle incorporation method, an adhesive (for example, an epoxy resin) and the substantially spherical particles 51 (having an average particle size of 10 micrometers, for example) are first mixed with each other, and then the obtained mixture is applied to the base material 50 by a roll coater method (thickness: 5 to 20 micrometers) so that the particles are dispersed in the adhesive and bonded with the base material, obtaining a desired uneven surface form.

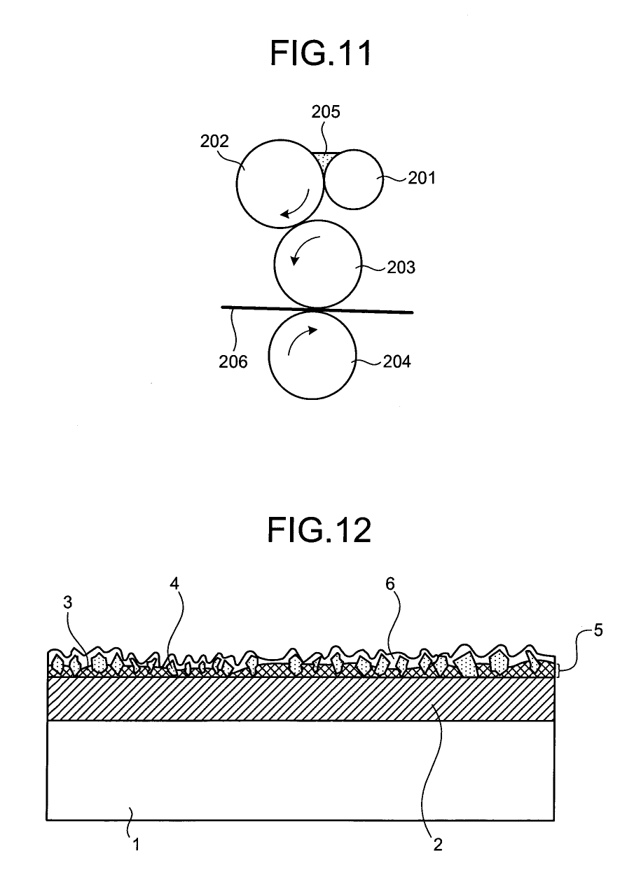

An example of a method for controlling the coating thickness in a roll coater method is described with reference to FIG. 11.

As shown in FIG. 11, (Control 1) the feed rate of epoxy adhesive 205 is first controlled by appropriately changing the nip width between a pair of a first roller 201 and a second roller 202.

(Control 2) The adhesion of the adhesive to a base material 206 is then controlled by appropriately changing the nip width between a third roller 203 and a fourth roller 204.

After the controls (1) and (2), an adhesive is applied to a base material 300×300 mm square, and a coating thickness is determined by making a calculation from the following formula (A).

Coating thickness=[(Weight after application−Weight before application)/Specific gravity]/Coating area (A)

A desired uneven surface form (such that the surface roughness height Rz is 5 to 20 micrometers and the roughness pitch Rs is 20 to 100 micrometers) is preferably evaluated in terms of, for example, a coefficient of friction of the surface.

It is preferred that the coefficient of friction of the surface is in the range of from 0.5 to 0.2.

In this case, the surface has substantially an uneven form and avoids resistance during cleaning of the surface using a waste cloth or the like.

A coefficient of friction of the surface is measured by a method in accordance with the “Method for determining coefficient of friction of paper and board” described in JIS P8147 using an autograph (for example, “AG-IS 100kN (trade name)”, manufactured by Shimadzu Corporation) as a test apparatus.

As shown in FIG. 2, an intermediate layer 55 can be formed between the fixing layer 52 and the low-surface-tension coating layer 53 to further improve the bonding between them.

With respect to the material constituting the intermediate layer 55, preferred is a material having high reactivity with the fixing layer 52 and high reactivity with the low-surface-tension coating layer 53, for example, a material having a hydroxyl group or a siloxane structure on the outermost surface. Specific examples of such materials include water-glass and a silane coupling agent.

Further, it is preferred that the intermediate layer 55 has a thickness in the range of from 0.2 to 2 micrometers.

When the thickness is more than 0.2 micrometer, it is preferable because the layer functions fully as an intermediate layer. When the thickness is equal to or less than 2 micrometers, it is preferable because the intermediate layer becomes hard to break.

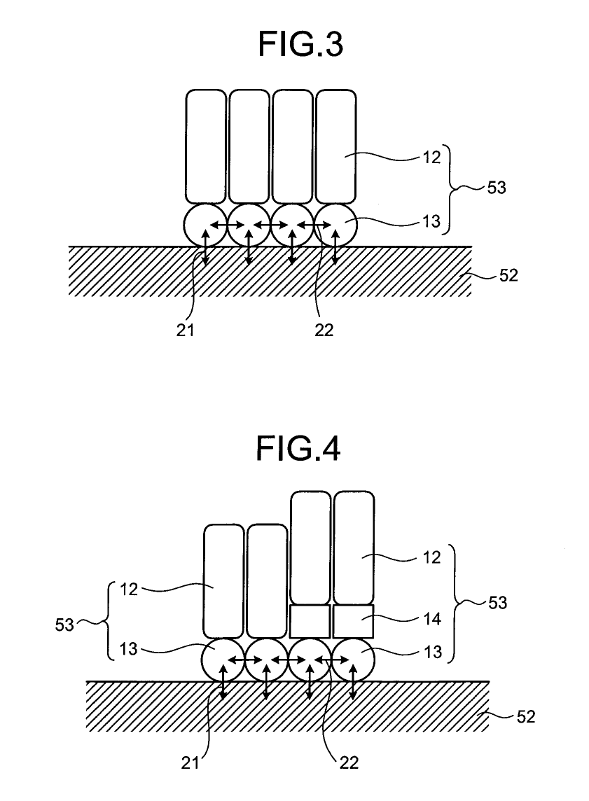

FIG. 3 is a schematic diagram for explaining a chemical interaction of the low-surface-tension coating layer 53.

As shown in FIG. 3, the low-surface-tension coating layer 53 includes a monomolecular layer of a compound having at least a low-surface-tension exhibiting unit 12 in contact with a printed item and a chemical reaction unit 13 that interacts with the surface of the base material (a first interaction 21).

In the present invention, the surface is covered with a monomolecular layer of a molecule having the low-surface-tension exhibiting unit 12 having high ink repellency and the chemical reaction unit 13 reactive with the surface of the fixing layer 52, and the obtained printed item contact member has high ink repellency and high durability.

As shown in FIG. 4, the low-surface-tension coating layer can have, for example, a third structure unit (for example, —O—) 14 between the low-surface-tension exhibiting unit 12 and the chemical reaction unit 13.

By the chemical reaction unit 13, a monomolecular film (Close packed & Lateral interacted Monolayer; CLM) having high density and having an interaction between adjacent molecules is formed.

With respect to the interaction between adjacent molecules (a second interaction 22), while the formation of chemical bonding is preferred, the formation of hydrogen bonding or bonding due to physical attractive force can be employed. The physical attractive force means so-called van der Waals force, and an action due to dipole attractive force, dispersion force, or induced dipole attractive force.

In the present invention, the reactive group in the chemical reaction unit reacts with an OH group present on the surface of the fixing layer 52. Particularly, with respect to the molecule having two or more Cls or ORs bonded to Si, when all the Cls or ORs in the molecule react with the base material, the number of bonds of the molecule to the base material is increased, improving the low surface-tension layer in durability.

Further, even when all the Cls or ORs are not able to react with the base material, Cl or OR, which does not react with the fixing layer 52, reacts with unreacted Cl or OR in the adjacent molecule to form intermolecular bonding, improving the film strength.

Even when no chemical bonding is formed between the molecules, all the molecules reacted with the fixing layer 52 have their reactive groups located on the side of the fixing layer 52 to form a low-surface-tension exhibiting unit arranged on the outside, so that the molecules attract to one another due to physical attractive force. Therefore, a monomolecular film (Close packed & Lateral interacted Monolayer: CLM) having high density and having an interaction between adjacent molecules is formed, as compared to a film in which the molecules are randomly present, thus achieving significantly improved film strength.

That is, a functional group having a low polarity is incorporated into the low-surface-tension exhibiting unit to improve the ink repellency, and, on the other hand, a reactive group forms strong chemical bonding with the surface of the fixing layer 52 to constitute a film having high durability. Further, the molecules have molecular chains arranged substantially perpendicular to the surface of the fixing layer 52, and therefore high filling density of molecules is obtained, and the molecular interaction (chemical bonding, hydrogen bonding, or physical attractive force) improves the film strength, making it possible to obtain a printed item contact member having high durability and high ink repellency.

As examples of the chemical reaction unit 13, there can be mentioned an epoxy group, an isocyanate group, or a group represented by the formula (1) below.

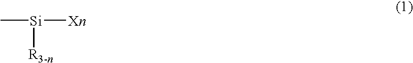

where X represents OR′ or Cl,
n represents an integer of 1 to 3, and
each of R and R′ represents an alkyl group,
and R and R′ have the same or different number of carbon atom(s).

Examples of compounds having an epoxy group represented by the formula (2) below include 1,2-epoxydecane, 1,2-epoxydodecane, 1,2-epoxyhexadecane, and 1,2-epoxyoctadecane, however, the present invention is not particularly limited thereto.

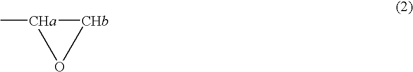

where each of a and b is an integer of 1 or 2.

Examples of compounds having an isocyanate group (R₁—N═C═O where R₁ represents an alkyl group) include dodecyl isocyanate, octadecyl isocyanate, and propyltriethoxysilane 3-isocyanate, however, the present invention is not limited thereto.

Examples of compounds having a group represented by the formula (1), where X is Cl, include octadecyldimethylchlorosilane, octadecylmethyldichlorosilane, and octadecyltrichlorosilane. Examples of compounds having a group represented by the formula (1), where X is alkoxide OR′, include hexyltrimethoxysilane, octadecylmethyldimethoxysilane, octadecyltriethoxysilane, and octadecyltrimethoxysilane, however, the present invention is not limited thereto.

The low-surface-tension exhibiting unit 12 has a fluorine atom.

That is, for forming the low-surface-tension exhibiting unit 12, a structure in which at least part of H atoms in the carbon chain are replaced by an F atom may be formed in the compound.

Accordingly, by replacing at least part of H atoms in the carbon chain by an F atom, the polarity of the low-surface-tension exhibiting unit becomes lower, further improving the ink repellency.

Examples of the compounds having a group represented by the formula (1), where X is Cl, include trifluoropropyltrichlorosilane, heptadecafluorodecylmethyldichlorosilane, heptadecafluorodecyltrichlorosilane, and tridecafluorooctyltrichlorosilane. Examples of the compounds having a group represented by the formula (1), where X is alkoxide OR′, include trifluoropropyltrimethoxysilane, heptadecafluorodecylmethyldimethoxysilane, heptadecafluorodecyltrimethoxysilane, heptadecafluorodecyltriethoxysilane, tridecafluorooctyltrimethoxysilane, and a fluorine-based surface treatment agent “OPTOOL DSX” (trade name: manufactured by DAIKIN INDUSTRIES, Ltd.), however, the present invention is not limited thereto.

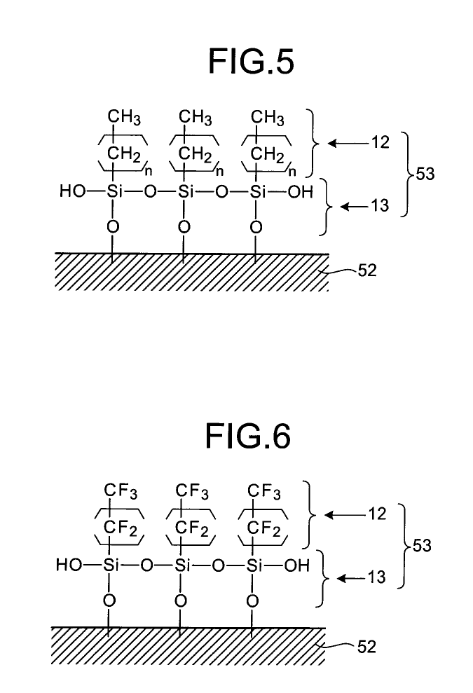

FIG. 5 is a schematic diagram showing an example of the formula (1), and FIG. 6 is a schematic diagram showing an example in which an F group is incorporated into the molecule.

When an F atom is incorporated into the molecule to improve the ink repellency, the molecular interaction as physical attractive force in the obtained monomolecular layer becomes small. The reason for this resides in that the CF₂ repeating carbon chain is small in polarization in the molecule, as compared to the CH₂ repeating carbon chain, thus reducing the cohesive force between the molecules.

Accordingly, the incorporation of an F atom reduces the surface tension.

For the same reason, Teflon® has a low wear resistance such that the cohesive force between molecules is small. Therefore, a conventional impression cylinder jacket having a surface merely covered with a fluororesin, which cannot be expected to react with the fixing layer, has low durability.

In the present invention, the printed item contact member is covered with a monomolecular layer of a molecule having a low-surface-tension exhibiting unit having high ink repellency and being reactive with the surface of the fixing layer 52, and therefore has both high ink repellency and high durability.

In the present invention, the reactive group in the compound reacts with an OH group present on the surface of the fixing layer 52. Particularly, with respect to the molecule having two or more Cls or ORs bonded to Si, it is presumed that, when all the Cls or ORs in the molecule react with the fixing layer 52, the number of bonds of the molecule to the fixing layer 52 is increased, improving the low surface-tension layer in durability.

Even when all the Cls or ORs are not able to react with the fixing layer 52, Cl or OR, which does not react with the fixing layer 52, reacts with unreacted Cl or OR in the adjacent molecule to form intermolecular bonding, improving the film strength.

That is, in the low-surface-tension exhibiting unit 12, an F atom is incorporated to lower the polarity, improving the ink repellency. On the other hand, in the chemical reaction unit 13, a reactive group forms strong chemical bonding with the surface of the fixing layer 52. As a result, a film having high durability is formed by a synergy between the low-surface-tension exhibiting unit and the chemical reaction unit.

Particularly, a molecule having Si—Cl or Si—OR forms three chemical bonds or less per molecule, together with the fixing layer 52, to improve the durability. Alternatively, Si—Cl or Si—OR that cannot react with the fixing layer 52 is bonded to that in another molecule to improve the film in strength, and to enhance the durability.

Further, it is preferable that the compound constituting the low-surface-tension coating layer 53 has a density higher than 2 molecule/nm².

An example of a method of checking whether the compound has a density higher than 2 molecule/nm² is described below.

XPS (X-ray photoelectron spectroscopy) is used as the measurement method. In the XPS, the surface of a sample is irradiated with X-ray, and energy of electrons emitted from the surface (depth: several nanometers) is analyzed to measure the types and amounts of elements and the state of chemical bonding of elements.

The amounts of elements (amounts of fluorine and carbon in this case) are measured by the above method, and the amount of fluorine material molecules present per unit area is determined by making a calculation to check whether the compound has a density higher than 2 molecule/nm².

An example of the measurement apparatus is “model number: JPS-90MX”, manufactured by JEOL limited.

It is set that the compound constituting the low-surface-tension coating layer has a density higher than 2 molecule/nm², because not only can the surface tension be reduced to achieve excellent ink repellency or to properly prevent adhesion of ink, but also the coating layer can exhibit an excellent molecular interaction and high durability.

A silica compound layer can be formed between the fixing layer 52 and the low-surface-tension coating layer.

The bulk of the silica compound layer is comprised mainly of a silicon atom (Si) and an oxygen atom (O), and the surface of the layer is covered with a satisfactory amount of OH groups. Therefore, the compound forming the low-surface-tension coating layer can undergo a reaction in a dense state, thus exhibiting high ink repellency.

When the silica compound layer is formed between the fixing layer 52 and the low-surface-tension coating layer 53 to cover the fixing layer 52, there is substantially no effect of a difference of the composition of the fixing layer 52 on the low-surface-tension coating layer 53.

Further, the silica compound layer reacts with or closely adheres due to the polar group to an OH group or a COOH group present on the surface of the fixing layer 52, and therefore the fixing layer 52, silica compound layer, and low-surface-tension coating layer can form a structure in which the layers are strongly joined together.

Examples of compounds forming the silica compound layer include polysilazane, lithium silicate, and silica sol, however, the present invention is not limited thereto.

The printed item contact member according to the present invention can be applied to a coating sheet or coating layer including a resin, metal, or a composite material thereof as a base material, an ink contact portion of a member for various printing apparatuses, and a non-sticking portion for oil other than ink, or adhesive.

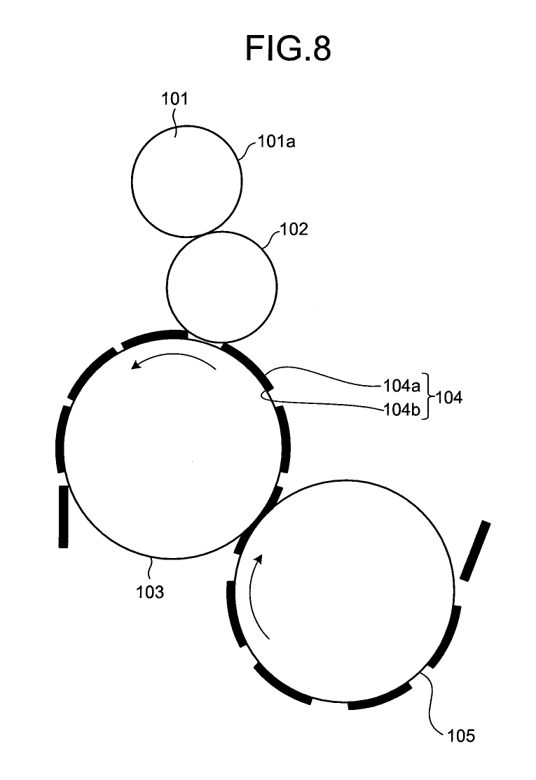

Specific examples of applications to which the printed item contact member according to the present invention is applied include an impression cylinder 103 shown in FIG. 8 or an intermediate cylinder for a sheet-feed press in contact with the surface of printing paper, and a guide roller or a turn bar for a rotary press.

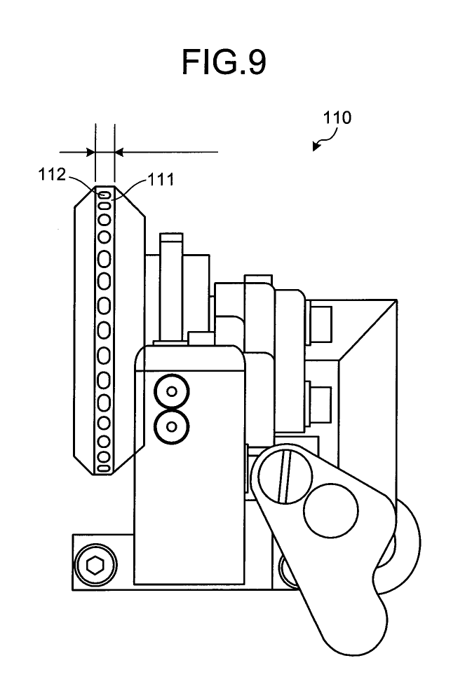

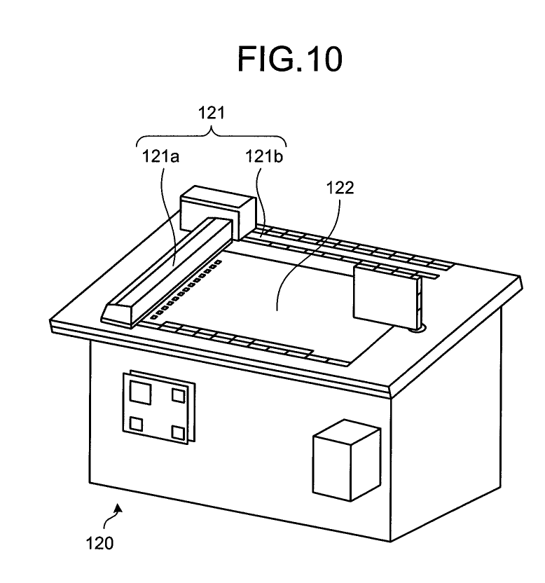

With respect to the applications in connection to a printing device other than the impression cylinder 103, the printed item contact member according to the present invention can be applied to a vacuum suction system 110 shown in FIG. 9 for a sheet-feed press, a fixing plate 122 shown in FIG. 10, which is an adsorption board for tone controller, and a connecting cylinder, an ink doctor, or an ink tray for a sheet-feed perfecting press.

With respect to the applications other than the printing device, the printed item contact member according to the present invention can be applied to a conveyer roller for an adhesive material, such as a pressure-sensitive adhesive tape, a layer for preventing adhesion, which is formed in a release material to which, for example, a bill having an adhesive layer on the back surface is temporarily attached, facilitating the peeling, and a non-sticking member for oil other than ink or adhesive, for example, a non-sticking layer of a cutter blade.

An example of a printing part of a sheet-feed offset perfecting press to which the printed item contact member according to the present invention is applied is explained below with reference to FIG. 8.

As shown in FIG. 8, a printing part of the printing device has a printing unit that includes a plate cylinder 101 having a press plate 101a where an ink is fed to the press plate 101a from an ink feeder (not shown) through an ink feed roller (not shown), a blanket cylinder (rubber blanket cylinder) 102 that is pressed and in contact with the plate cylinder 101 where the ink fed to a pattern portion of the press plate 101a is transferred to the blanket cylinder, the impression cylinder (also called printing cylinder or cylinder) 103 functioning as a printing cylinder pressed and in contact with the blanket cylinder 102 through a printing paper 104, and an intermediate cylinder 105 that feeds the printing paper 104 to the impression cylinder 103.

A nip pressure caused by the blanket cylinder 102 and the impression cylinder 103 is applied to the printing paper 104 passing between the blanket cylinder 102 and the impression cylinder 103, so that an ink according to a pattern is transferred from the blanket cylinder 102 to one surface (the top surface as viewed in the drawing) 104a of the printing paper, achieving printing. An ink according to a pattern (not shown) has been transferred from the blanket cylinder 102 to another surface (the bottom surface as viewed in the drawing) 104b of the printing paper 104 like the surface 104a in the upstream region of the printing unit shown in the drawing, and the ink transferred to the surface 104b of the printing paper 104 is in contact with the impression cylinder 103 under the nip pressure, so that the ink on the surface 104b of the printing paper 104 is very likely to adhere to the surface of the impression cylinder 103.

The printed item contact member according to the present invention is covered with a monomolecular layer of a molecule having the low-surface-tension exhibiting unit 12 having high ink repellency and the chemical reaction unit 13 reactive with the surface of the fixing layer 52 and therefore, when the present invention is applied to the impression cylinder 103, the obtained impression cylinder jacket exhibits high ink repellency and high durability.

In this example, explanations have been made on the sheet-feed offset perfecting press, however, the present invention is not limited thereto, and can be similarly applied to perfecting printing using an impression cylinder-type offset rotary press.

FIG. 9 is a schematic diagram of a vacuum suction system as another example to which the printed item contact member according to the present invention is applied. When the printed item contact member in the present example is applied to the surface of an adsorption pad 111 having adsorption holes 112 for the vacuum suction system 110 shown in FIG. 9, vacuum for the printing device can be stopped.

As a result, with respect to the contact portion of the vacuum suction system with the paper surface, conventionally, the position of the vacuum suction system is controlled by selecting a portion of the paper surface other than the printed portion. However, by applying the printed item contact member according to the present invention to the surface of a pad, the paper surface can be stopped at an arbitrary position of the vacuum suction system, irrespective of printing on the paper surface.

FIG. 10 is a schematic diagram of a color measurement apparatus as another example to which the printed item contact member according to the present invention is applied. As shown in FIG. 10, a color measurement apparatus 120 includes the fixing plate 122 onto which a printed item as a sample to be measured is placed and temporarily adsorbed during the measurement, and a measurement apparatus 121 that measures a pattern color of the printed item, where the printed item contact member is applied to the fixing plate 122.

In this example, the measurement apparatus 121 is a scanning device that includes a color measurement sensor 121a and a scanner 121b for scanning the color measurement sensor to measure a color with respect to the whole surface of the printed item placed on the fixing plate 122. Instead of the scanning device, a camera device, such as a CCD, can be used.

The fixing plate 122 has formed a number of grooves (not shown) in a radial form from one corner portion on the start side of the scanner 121b (on the left in this example), and in each of the grooves are formed pores (not shown) at predetermined intervals. The pores temporarily fix the printed item by an operation of vacuum from an air chamber (not shown) provided on the back side of the fixing plate 122.

The printed item contact member according to the present invention is covered with a monomolecular layer of a molecule having the low-surface-tension exhibiting unit 12 having high ink repellency and the chemical reaction unit 13 reactive with the surface of the base material and therefore, when the present invention is applied to the fixing plate 122, the obtained fixing plate exhibits high ink repellency and high durability.

### EXAMPLES

Specific Examples exhibiting the effects of the present invention are explained below; however, the present invention is not limited thereto.

### Example 1

FIG. 1 is a schematic configuration diagram of a printed item contact member in Example 1.

As shown in FIG. 1, a 0.15-mm base material 50 made of metal was coated with the fixing layer 52 comprised of a two-pack epoxy adhesive with a thickness of about 20 micrometers, and the substantially spherical particles 51 made of a ceramic having an average particle size of 10 micrometers were dispersed in the adhesive and bonded with the base material to obtain an uneven surface form having a roughness height of 10 micrometers and a roughness pitch of 100 micrometers. The obtained surface had a coefficient of friction of 0.4, and, when the surface was rubbed by cloth or the like, the surface did not catch it.

With respect to the two-pack epoxy adhesive, an adhesive including a base resin “2022S” (model number) and a curing agent “2105C” (model number), manufactured by ThreeBond Co., Ltd., was used.

As a release agent, an ethanol solution of tridecafluorooctyltrimethoxysilane (manufactured by GE Toshiba Silicones Co., Ltd.) was applied to the above-obtained surface, and heated at 100° C. for one hour to form the low-surface-tension coating layer 53, preparing a printed item contact member.

The obtained surface had a roughness height of 20 micrometers and a roughness pitch of 100 micrometers, which confirmed that the uneven form of the surface of the base material was not changed after the low-surface-tension coating layer 53 was formed.

The printed item contact member was used as an impression cylinder jacket for a printing device and subjected to a printability test.

In this test, a printing ink (“TOYO HY-UNITY Black” (trade name); manufactured by Toyo Ink Mfg. Co., Ltd.) was printed with a thickness of 1.2 micrometers on coat paper by means of an element tester, and then immediately passed under a roller covered with the printed item contact member.

From image processing for the printing surface having passed under the roller, it was found that the pinhole ratio (printing quality lowering ratio) was 1% or less, which has confirmed that there can be obtained printing quality equivalent to the quality obtained in single-side printing in which the printing surface is not in contact with the impression cylinder.

The printed item contact member had excellent durability.

As described above, when spherical ceramic particles are dispersed in and bonded with the two-pack epoxy adhesive applied in a small thickness, the two-pack epoxy adhesive covers the whole of the particles due to surface tension, and further the two-pack epoxy adhesive penetrates the micropores in the particles, forming an uneven surface form with satisfactory strength.

In contrast, a phenolic resin is conventionally further applied to the dispersed and bonded particles. From the above, it is apparent that, by controlling the particles to be substantially spherical, the uneven surface form can be finely controlled, making it possible to further reduce the occurrence of pinholes (printing quality difference).

Further, by using as a release agent a low-molecular material reactive with the base material, release treatment using a monomolecular layer for the uneven surface can be achieved, making it possible to exhibit a releasing effect while maintaining the micro-uneven surface form of the base material.

As a result, a release surface having a surface form such that the roughness height is small (for example, 10 micrometers) and the roughness pitch is small (for example, 100 micrometers), which has conventionally been difficult to produce, can be produced, making it possible to further reduce the occurrence of pinholes (printing quality difference)(1%).

It is thought that the reactive group bonded to Si contained in the low-surface-tension coating layer 53, which is the release agent in the Example, reacts with an OH group present on the surface of the base material to form a strong release film, improving the non-sticking film in durability.

It is thought that, even when all the reactive groups do not react with the base material, the unreacted reactive group reacts with a reactive group in the adjacent molecule to form a strong film, improving the non-sticking film in durability.

### Example 2

A base material was prepared in the same manner as in Example 1, and spherical ceramic particles having an average particle size of 10 micrometers were dispersed in the adhesive and bonded with the base material to obtain an uneven surface form having a roughness height of 10 micrometers and a roughness pitch of 100 micrometers. The obtained surface had a coefficient of friction of 0.4, and when the surface was rubbed by cloth or the like, the surface did not catch it.

Fluorine-based agent EGC-1720 (trade name; manufactured by 3M) was applied to the obtained surface, and heated at 100° C. for one hour to form the low-surface-tension coating layer 53, preparing a printed item contact member.

The obtained surface form had a roughness height of 10 micrometers and a roughness pitch of 100 micrometers that are similar to those before the low-surface-tension coating layer 53 was formed, which confirmed that the uneven form of the surface of the base material was not changed after the low-surface-tension coating layer 53 was formed.

The printed item contact member was subjected to printing test in the same manner as in Example 1. It was found that the pinhole ratio was 1% or less, which has confirmed that there can be obtained printing quality equivalent to the quality obtained in single-side printing in which the printing surface is not in contact with the impression cylinder.

The results confirmed that the non-sticking material used in the Example has one reactive group bonded to Si in the molecule, however, it can react with an OH group present on the surface of the base material to form a strong film.

It is presumed that the non-sticking material has one reactive group and hence the non-sticking structure is arranged in the opposite direction of the surface of the base material, thus further improving the non-sticking effect.

In contrast, in a conventional resin, molecules are randomly arranged and the non-sticking structure is not always arranged in the direction of the outermost surface, and therefore the improvement of non-sticking effect cannot be expected.

### Example 3

An uneven base material was prepared in the same manner as in Example 2, and, as shown in FIG. 2, 1,2-bis(triethoxysilyl)ethane was applied as the intermediate layer 55 to the base material, and heated at 80° C. for one hour, and then an ethanol solution of tridecafluorooctyltrimethoxysilane (manufactured by GE Toshiba Silicones Co., Ltd.) was applied to the intermediate layer in the same manner as in Example 1, and heated at 100° C. for one hour to form the low-surface-tension coating layer 53, preparing a printed item contact member.

With respect to the method of applying the intermediate layer or the like, a spraying method was employed. The coating thickness was controlled by the following method.

(1) A sprayed amount from a spray nozzle per unit time is measured first.

(2) A coating area per unit time is measured.

(3) A coating thickness is determined from the formula: (Sprayed amount)/(Coating area).

The coating thickness was thus controlled by appropriately changing the sprayed amount and the coating area (the speed of travel of the spray nozzle).

With respect to the spraying method, an apparatus generally having a mechanism in which a nozzle travels on a stage in the X-Y direction was used, and, with respect to the spray nozzle, “STS-6R” (model number), manufactured by FUSO SEIKI CO., LTD., was used.

The obtained surface form had a roughness height of 10 micrometers and a roughness pitch of 100 micrometers, which are almost the same as those before the release agent was applied, which confirmed that the uneven form of the surface of the base material was not changed after the intermediate layer and the low-surface-tension coating layer 53 were formed.

The printed item contact member was subjected to printing test in the same manner as in Example 1. As a result, it was found that the pinhole ratio was 1% or less, which has confirmed that there can be obtained printing quality equivalent to the quality obtained in single-side printing in which the printing surface is not in contact with the impression cylinder.

By forming the intermediate layer 55 of 1,2-bis(triethoxysilyl)ethane on the uneven surface structure comprised of ceramic particles, the reaction density of the low-surface-tension coating layer 53 can be increased, further improving both the non-sticking performance and the durability.

The reason for this resides in that the fluorine-containing molecule contained in the material constituting the low-surface-tension coating layer 53 has in its molecule a portion capable of reacting (silane coupling reaction) with an OH group present on the surface of the base material (the uneven surface of the fixing layer 52), and therefore the molecule is bonded to the surface with chemical bonding (covalent bonding), thereby improving the adhesion (durability).

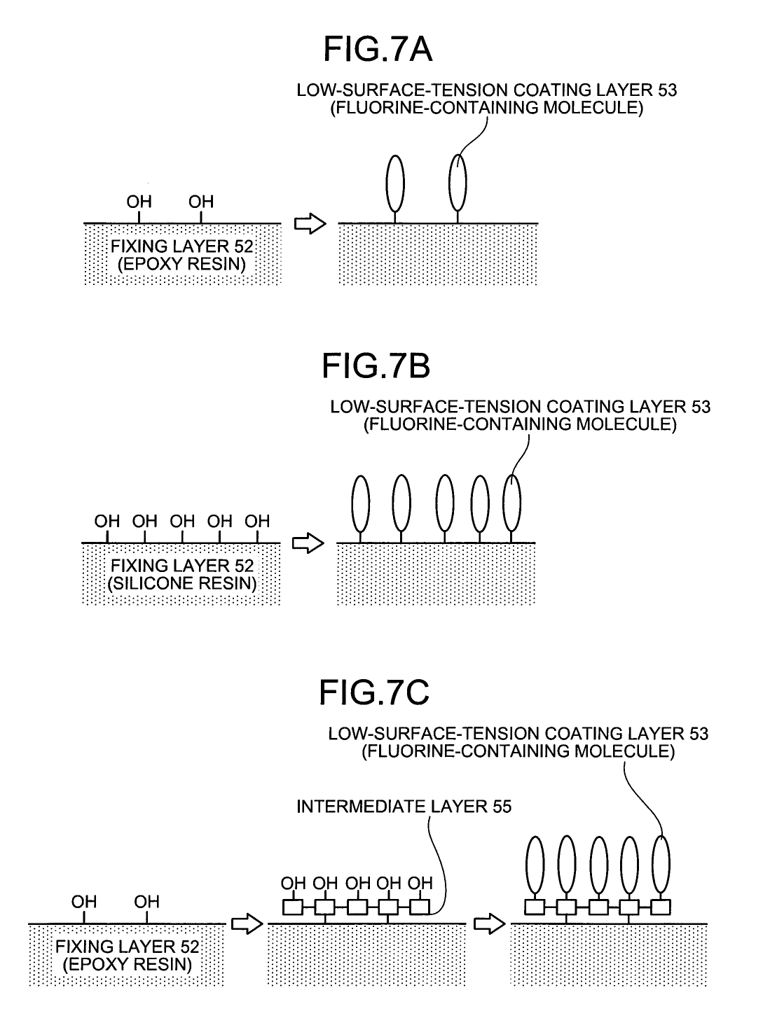

When the reaction rate (density) of the fluorine-containing molecules is reduced, the releasing effect becomes poor. With respect to the material used in the present Example, as shown in FIGS. 7A and 7B, as compared to the epoxy resin used as the fixing layer 52, the silica material has a large amount of OH groups on the surface to increase the reaction rate of the fluorine-containing molecules, improving the releasing effect.

In contrast, as shown in FIG. 7C, 1,2-bis(triethoxysilyl)ethane used in the present Example has a structure such that it is present on the side of the base material (uneven surface) and it has OH groups on the opposite side of the base material (on the side of the outermost surface), and further, utilizing properties such that the adjacent molecules chemically react with each other, it has an increased number of OH groups reacting with the fluorine-containing molecules rather than the epoxy resin to enhance the bonding of molecules, improving the adhesion.

### INDUSTRIAL APPLICABILITY

As described above, the printed item contact member according to the present invention includes a base material, a fixing layer that is formed on the surface of the base material and substantially spherical particles are fixed thereto, and a low-surface-tension coating layer that covers the surface of the fixing layer having the substantially spherical particles fixed thereto and that exhibits release properties with respect to a printed item, and the printed item contact member exhibits high ink repellency while maintaining the micro-uneven surface structure and is free from adhesion of yarn waste or dust to the member during cleaning, and therefore can be suitably used as, for example, a member for a printing device in contact with the surface of printing paper.

1. A printed item contact member comprising:
a base material;
a fixing layer that is formed on a surface of the base material and substantially spherical particles are fixed thereto; and
a low-surface-tension coating layer that covers a surface of the fixing layer having the substantially spherical particles fixed thereto and that exhibits release properties with respect to a printed item.

2. The printed item contact member according to claim 1, wherein the substantially spherical particles have a particle size of 1 to 20 micrometers, and
the surface covered with the low-surface-tension coating layer has a surface roughness such that a height Rz is 5 to 20 micrometers and a roughness pitch Rs is 20 to 100 micrometers.

3. The printed item contact member according to claim 1, wherein the low-surface-tension coating layer has a thickness equal to or less than 1 micrometer.

4. The printed item contact member according to claim 1, wherein the fixing layer has a thickness of 5 to 30 micrometers.

5. A printed item contact member comprising:
a base material;
a fixing layer that is formed on the surface of the base material and substantially spherical particles are fixed thereto; and
a low-surface-tension coating layer that covers a surface of the fixing layer having the substantially spherical particles fixed thereto and that exhibits release properties with respect to a printed item, wherein
the low-surface-tension coating layer having a thickness equal to or less than 1 micrometer, and
the low-surface-tension coating layer includes a compound having a low-surface-tension exhibiting unit in contact with a printed item and a chemical reaction unit that interacts with the surface of the base material.

6. A printed item contact member comprising:
a base material;
a fixing layer that is formed on the surface of the base material and substantially spherical particles are fixed thereto; and
a low-surface-tension coating layer that covers a surface of the fixing layer having the substantially spherical particles fixed thereto and that exhibits release properties with respect to a printed item, wherein
the low-surface-tension coating layer having a thickness equal to or less than 1 micrometer,
the low-surface-tension coating layer includes a compound having a low-surface-tension exhibiting unit in contact with a printed item and a chemical reaction unit that interacts with the surface of the base material, and
the low-surface-tension coating layer includes a monomolecular layer of the compound.

7. The printed item contact member according to claim 5, wherein the chemical reaction unit includes an uneven surface having the substantially spherical particles and fixing layer formed on the surface of the base material, and a replacement reactive structure.

8. The printed item contact member according to claim 5, wherein the low-surface-tension exhibiting unit has fluorine atom.

9. The printed item contact member according to claim 5, wherein the compound constituting the low-surface-tension coating layer has a density higher than 2 molecule/nm².

10. The printed item contact member according to claim 5, further comprising a silica compound layer which is an intermediate layer between the base material and the low-surface-tension coating layer.

11. A member for a printing apparatus comprising the printed item contact member according to claim 1.

12. The member for a printing apparatus according to claim 11, wherein the member is any one of an impression cylinder, a sample table, a vacuum suction system, or a color measurement apparatus.
